(19) United States
(12) Patent Application Publication
(10) Pub. No.: US 2015/0347342 A1
(43) Pub. Date: Dec. 3, 2015

(54) TERMINAL BOARD ARCHITECTURE FOR UNIVERSAL I/O ALLOWING SIMPLEX OR REDUNDANT DEVICES

(71) Applicant: GE Intelligent Platforms, Inc., Salem, VA (US)

(72) Inventors: Daniel Milton ALLEY, Salem, VA (US); Alan Carroll LOVELL, Salem, VA (US); Christopher Todd MOORE, Salem, VA (US)

(21) Appl. No.: 14/294,628

(22) Filed: Jun. 3, 2014

(51) Int. Cl. G06F 13/40; G06F 13/42

(52) U.S. Cl. CPC G06F 13/4068; G06F 13/4221

(57) ABSTRACT

Provided is an interface architecture for an application specific integrated circuit (ASIC). The interface architecture includes a circuit board layout including slots for electrically coupling to (n) number of acquisition boards, each acquisition board being configured to accommodate (m) universal channels. The interface architecture is connectable to a plurality of terminal board types and can be configured to accommodate a predetermined multiple of (m) universal channels.

### FIELD OF THE INVENTION

The present invention relates generally to universal analog input/output (I/O) devices that enable either simplex or redundant operations.

### BACKGROUND OF THE INVENTION

Conventional universal I/O modules are designed to provide a common interface between multiple electromechanical systems. A common feature of these I/O modules is the ability to plug into multiple terminal boards. Terminal boards, however, often include many different varieties, each being able to accommodate different numbers and types of channels. These module designs are the more complicated when the channels are universal.

Many conventional limited mode universal I/O systems are available. Most of these systems include use of dual channels to monitor discrete digital I/O, with programmable pull up/down functions. This functionality, however, does not cover certain types of connecting modes, such as thermocouple, and mA inputs. Any dual nature associated with these systems only applies to acquisition hardware up to the I/O processor.

Other conventional systems have used combinations of software and hardware link with termination adapters to bridge across pairs of simplex modules plugged onto a backplane, with the backplane supporting dual Ethernet interfaces communicating to software modules performing voting. Still other designs provide terminal boards containing diode combinations for sensing and relays, connected by cables from separate simplex driver modules. These approaches do not address the Universal I/O perspective—just the redundancy.

### SUMMARY OF EMBODIMENTS OF THE INVENTION

Given the aforementioned deficiencies, a need exists for a system and method for providing architecture of an I/O pack to plug into a terminal board s varying in simplex, dual, and triple modular redundancy (TMR) while allowing varying numbers of universal channels.

Under certain circumstances, an embodiment of the present invention provides the interface architecture for an application specific integrated circuit (ASIC). The interface architecture includes a circuit board layout including slots for electrically coupling to (n) number of acquisition boards, each acquisition board being configured to accommodate (m) universal channels. The interface architecture is connectable to a plurality of terminal board types and can be configured to accommodate a predetermined multiple of (m) universal channels.

Further features and advantages of the invention, as well as the structure and operation of various embodiments of the invention, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS

The accompanying drawings, which are incorporated herein and form part of the specification, illustrate the present invention and, together with the description, further serve to explain the principles of the invention and to enable a person skilled in the relevant art(s) to make and use the invention.

FIG. 1 is an exemplary block diagram illustration of a universal I/O device constructed and arranged in accordance with embodiments of the present teachings.

FIG. 2A is an illustration of a universal 16 input/output point pack attached to a simplex 16 point terminal board in accordance with embodiments of the present teachings.

FIG. 2B is an illustration of internal components of the universal 16 input/output point pack in FIG. 2A.

FIG. 3A is an illustration of a universal 32 input/output point pack attached to a simplex 32 point terminal board in accordance with embodiments of the present teachings.

FIG. 3B is an illustration of internal components of the universal 32 input/output point pack in FIG. 3A.

FIG. 4 is an illustration of universal 16 input/output point packs interconnected and attached to a terminal board to provide dual or triple module redundancy in accordance with embodiments of the present teachings.

FIGS. 5A-5K are more detailed block diagram illustrations of the exemplary I/O device of FIG. 1 associated with various signal types in accordance with embodiments of the present teachings.

FIG. 6 is an illustration of a simplex signal flow in accordance with embodiments of the present teachings.

FIG. 7 is an illustration of triple module redundancy signal flow in accordance with embodiments of the present teachings.

FIG. 8 is a flowchart of an exemplary method of practicing the present invention in accordance with the present teachings.

### DETAILED DESCRIPTION OF EMBODIMENTS OF THE INVENTION

While the present invention is described herein with illustrative embodiments for particular applications, it should be understood that the invention is not limited thereto. Those skilled in the art with access to the teachings provided herein will recognize additional modifications, applications, and embodiments within the scope thereof and additional fields in which the invention would be of significant utility.

Various embodiments relate to a system and method that provides architecture for hardware wherein an input/output pack can be plugged into a terminal board. By varying the quantity of acquisition cards within the input/output pack and quantity of packs attached to the terminal board, the pack and terminal board architecture can provide different quantities of channels, as well as different levels of redundancies. In such an embodiment, the same circuit card can be used to provide different quantities of channels and different levels of redundancies by varying the quantity of connectors disposed along the terminal board and the interconnection between the connectors.

Various embodiments relate to a system and method wherein a single monitoring or control system can include several different levels of redundancies, such as simplex, dual and triple mode redundancy. Thus, simplex and redundant packs can be intermixed within the system.

Various embodiments provides architecture that supports multiple terminal boards configured for either 16 or 32 channels products capable of providing either simplex or redundant, for example, dual or triple modular redundancy (TMR) operations. Various embodiments provide a common connector type and pin out such that a pack may be inserted on either of the 16 channel terminal boards while supporting random programmable assignment for each channel to a variety of operating modes.

The board set within the pack is configured to accommodate one or two acquisitions boards, which in turn allows for 16 or 32 channel terminal boards. Various embodiments of the designs supports automatic reconfiguration and hot replacement of the pack on industrial controllers (e.g. Mark™ Vie products or any other Mark™ industrial controller available from General Electric of Schenectady, N.Y.).

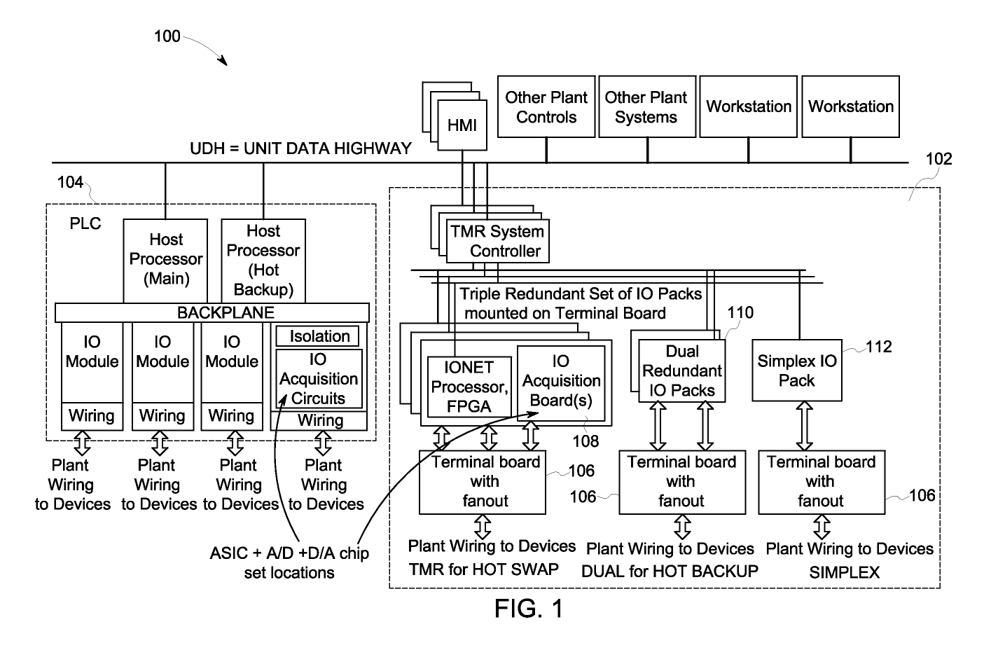

FIG. 1 is an illustration of system architecture 100 which includes a single control system 102 and a programmable logic controller (PLC) 104. As depicted, a single control system 104 supports several different levels of redundancies, which includes simplex input/output pack 112, dual redundant input/output packs 110, and triple module redundancy (TMR) input/output packs 108. Thus, different levels of redundancies are intermixed within the control system 102. Terminal fan boards 114 provide signal fan out, filtering, and sensing to support the simplex 112, dual 110, and TMR 108 applications, respectively.

The system architecture 100 shown in FIG. 1 is just one example of an embodiment according to the present teachings. Other configurations may be provided according to various embodiments. For example, in lieu of a system having different levels of redundancies intermixed, the system architecture may be designed having only a simplex configuration, a dual configuration, or a TMR configuration.

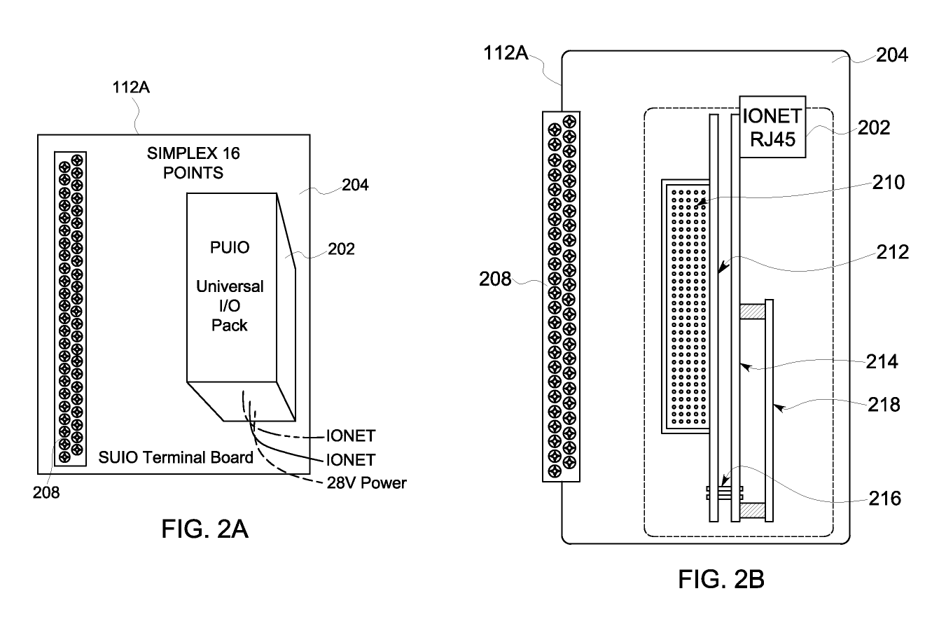

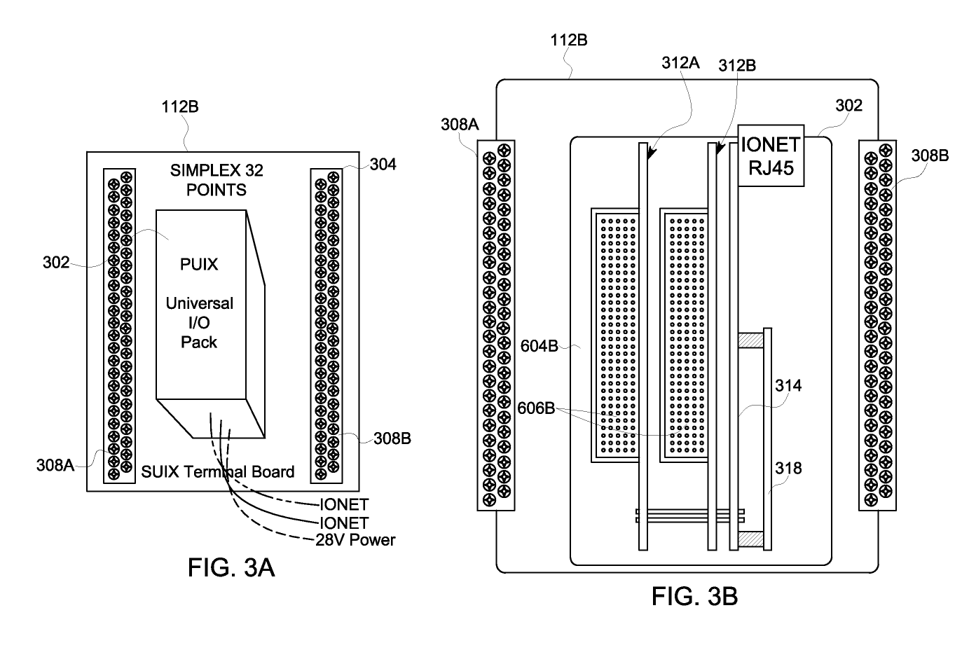

As shown and described in reference to FIGS. 2A-4, by arranging different quantities of acquisitions boards inside the input/output packs and by varying the quantity of input/output packs, the controller architecture can perform simplex operations, dual redundancy operations, TMR operations or a combination thereof with 16 or 32 channels. In various embodiments, simplex terminal board 112 shown in FIG. 1 can be configured having two different styles of simplex terminal boards 112a, 112b, as shown in FIGS. 2A-3B. In FIGS. 2A-2B, simplex terminal board 112a includes 16 channels where the input/output pack is packaged to hold one acquisition board.

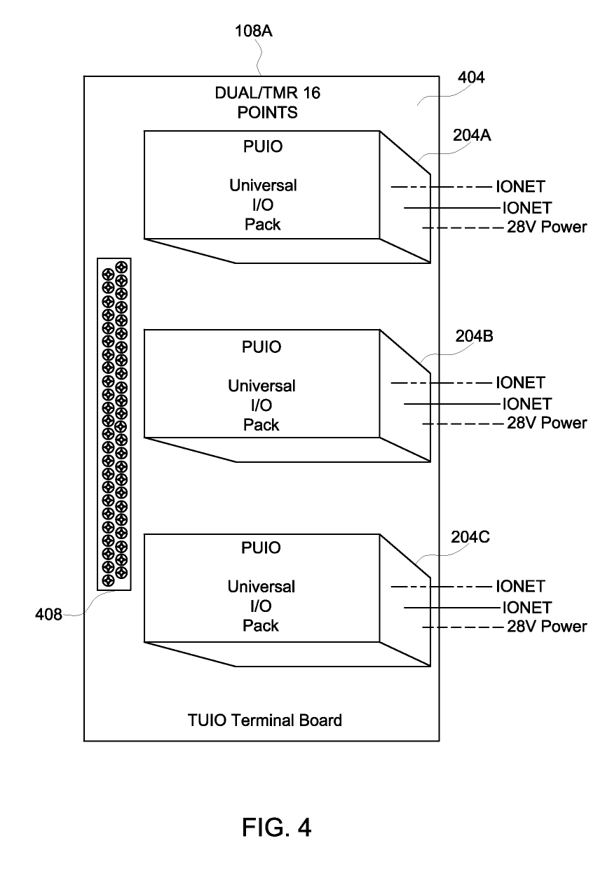

In FIGS. 3A-3B, simplex terminal board 112b includes 32 channels, where the input/output pack is packaged to hold two acquisition boards. Different levels of redundancy, such as dual redundant input/output packs 110 and TMR input/output packs 108, can be achieved by varying the quantity of input/output packs attached to the terminal boards, as shown in FIG. 4.

Specifically in reference to FIG. 2A, simplex terminal board 112a includes a universal 16 input/output point pack 202 mounted on terminal board 204 provided with 16 channel screws 208. FIG. 2B depicts exemplary internal components of the universal 16 input/output point pack 202 shown in FIG. 2A. As depicted, input/output pack 202 can be packaged to include an acquisition board 212, a power supply and carrier board 214, and a processor board 218.

In FIG. 2B, a DIN style connector 210 attaches to a single acquisition board 212. An attachment mechanism, such as pin 216, connects the power supply and carrier board 214 and the processor board 218 to the acquisition board 212. The acquisition board 212 connects to channel screws 208. The simplex 112a arrangement in FIGS. 2A and 2B includes only one acquisition board 212 and one processor board 218 within a single input/output pack 202. As such, no redundancy is provided.

FIGS. 3A and 3B illustrates another embodiment of simplex terminal board 112, shown in FIG. 1. In FIGS. 3A and 3B, simplex terminal board 112b includes a universal 32 input/output point pack 302 attached to a terminal board 304 provided with a pair of 16 channel screws 308a, 308b. In comparison to FIG. 2B which includes a single acquisition board 212, in FIG. 3B, the input/output pack 302 is packaged with two acquisition boards 312a, 312b, sharing a single processor and single power source. The acquisition boards 312a, 312b connect to channel screws 308a, 808b.

FIG. 4 illustrates that different levels of redundancy, such as dual redundant input/output packs 110 and TMR input/output pack 108 in FIG. 1, can be achieved by varying the number of input/output packs attached to the terminal boards. In FIG. 4, a TMR input/output pack 108a includes three universal 16 input/output packs 204a, 204b, 204c interconnected in parallel and attached to terminal board 404 with 16 channel screws 408. Input/output packs 204a, 204b and 204c are configured as described with regards to FIGS. 2A and 2B.

By combining the components to form different configurations, the system 100 is capable of performing simplex or redundant operations. Namely, by arranging the quantity of acquisition boards inside the input/output packs and the quantity of input/output packs mounted on the terminal boards, the system is capable of providing simplex, dual redundancy, TMR redundancy or a combination thereof. The system can also vary the quantity of input/output points.

The architecture permits a plurality of different configurations using the same circuit boards, changing the number of points applied and changing how the boards are interconnected.

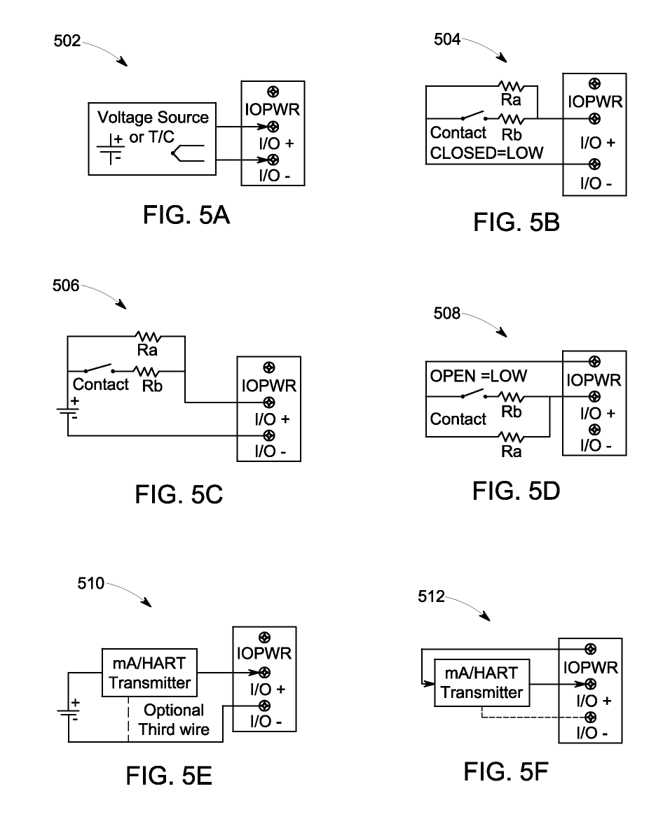

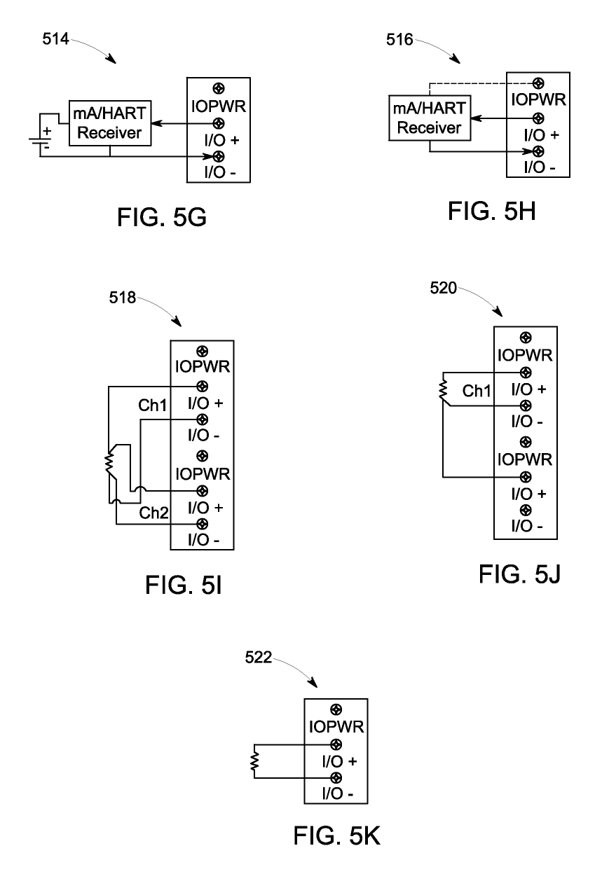

FIGS. 5A-5K, represented by circuits 502-522, illustrate a variety of different connections with various signal types. The universal I/O modules are configured to interface with several different signals. On the pack connector, each channel has a set of eight signals. Each input has a configuration that conditions the signal appropriately based on the attached sensor. The distinct signals are processed in a manner such that the processor can handle them universally. FIGS. 5A-5K illustrate examples of channel terminal block connections, such as resistance temperature detectors (RTD), voltage and thermocouple, and HART signals, to name a few. The circuits 502-508 shown in FIGS. 5A-5D, for example, are programmed for thermocouple or voltage input. The circuits 510-516 shown in FIGS. 5D-5H, for example, are programmed for HART signals. And, the circuits 518-522 shown in FIG. 5I-5K, for example, are programmed for assignment to RTD signals. Embodiments of the present invention are not limited to the implementations depicted in the circuits 502-522 shown in FIGS. 5A-5K.

By providing a common connector type and pin out, a pack may be inserted on either of the 16 channel terminal boards while supporting random programmable assignment of each channel to a variety of operating modes. The board set within the pack allows for one or two acquisition boards in turn allowing for 16 or 32 channel terminal boards. The design supports automatic reconfiguration and hot replacement of the pack.

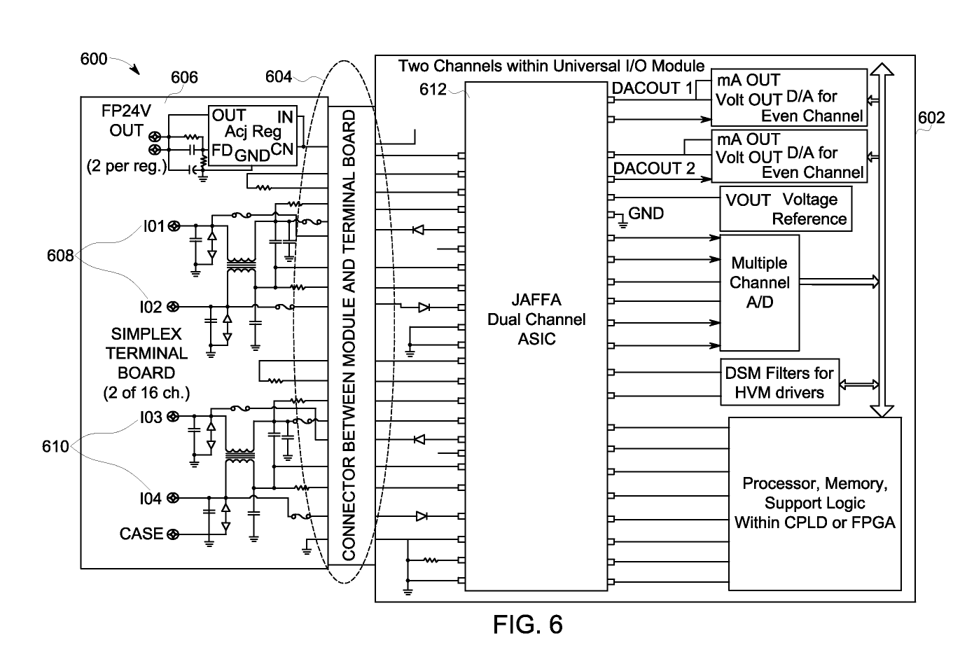

FIG. 6 illustrates an exemplary simplex flow 600 in accordance with embodiments of the present invention. More specifically, FIG. 6 is a more detailed illustration of simplex I/O pack 112 illustrated in FIG. 1, simplex 16 terminal board 112a shown in FIGS. 2A-2B, and simplex 32 terminal board 112b shown in FIGS. 3A-3B.

Further, FIG. 6 illustrates a circuit board 602 connected via connectors 604 to a terminal board 606. By applying a particular type of signal going through the connector, two channels in electrical communication between two sets of screws 608 and 610 are applied on the terminal board 606.

The ASIC 612 provides two sets of circuits. Each ASIC comprises two channels. FIG. 6 exemplifies pairs of channels. Other numbers of channels (i.e. 1, 3, or 4, etc.) are also permitted by this architecture.

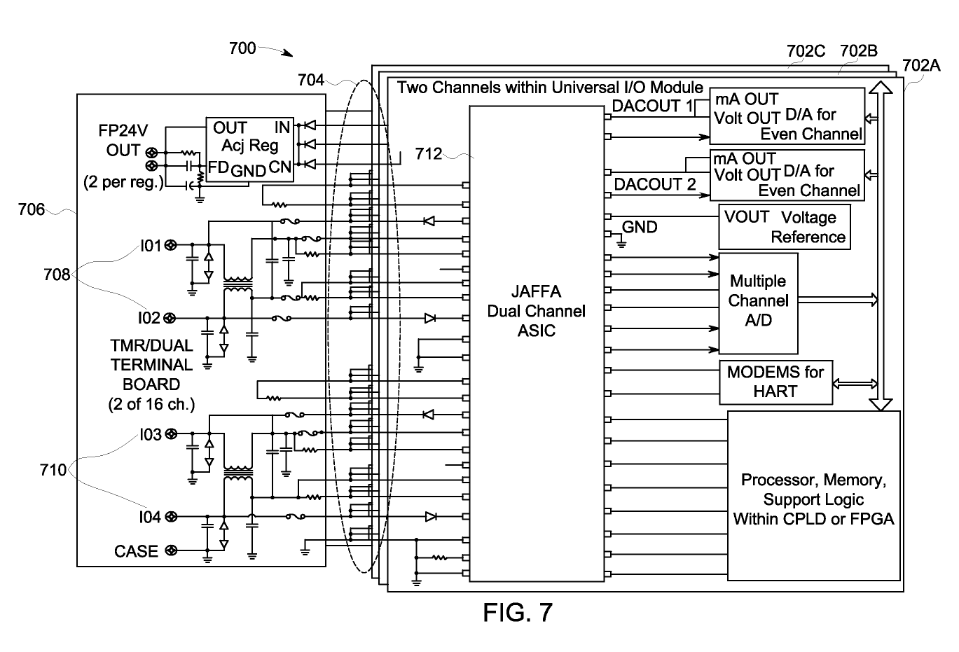

FIG. 7 illustrates an exemplary dual and TMR flow 700 in accordance with embodiments of the present invention. FIG. 7 illustrates for triple modular redundancy especially in the input. FIG. 7 is a more detailed illustration of the TMR input/output pack 108, 108a, shown in FIGS. 1 and 4, respectively.

More specifically, FIG. 7 illustrates three circuit boards 702A, 702B, and 702C connected via connectors 704 to respective terminal boards 706. The three circuit boards 702A, 702B, and 702C can be connected in parallel. Further, each of the circuit boards 702A, 702B, and 702C can be positioned on a different terminal board. The ASIC 712 provides two sets of circuits. Each ASIC comprises two channels between two sets of screws 708 and 710. FIG. 7 exemplifies pairs of channels similar to FIG. 6.

With this type of arrangement, modular redundancy is provided wherein the triple module redundancy shown in FIG. 7 can be easily reconfigured to provide dual redundancy (dual redundant pack 110 in FIG. 1) by unplugging one of the circuit boards. This entails unplugging a pack from its respective terminal board. The other two circuit boards which remain connected continue to perform the necessary measurement and control.

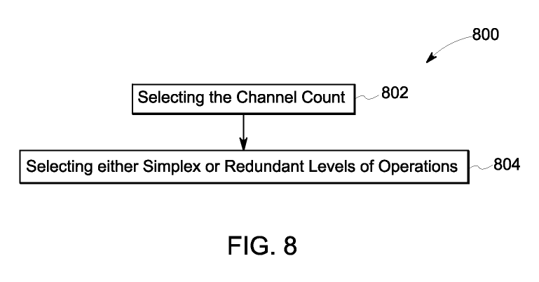

FIG. 8 is an illustration of an exemplary method 800 of practicing an embodiment of the present invention that supports a universal input/output device capable of providing different levels of redundancy by combining modules with varying levels of redundancy and channel count. In Step 802, the channel count is selected. The channel count may be either 16 or 32 input/output points based on the number of acquisition board packaged within the input/output pack and channel screws attached to the terminal board. Each of the acquisition boards corresponds to at least one of the channels. The board set within the pack allows for one or two acquisition boards, which in turn allows for 16 or 32 channel terminal boards.

In Step 804, either simplex or redundancy operation is selected based on the quantity of input/output boards attached to the terminal board(s). The system is expandable from a single simplex unit up to multiple redundant units. Simplex and redundant units can be mixed within the same system. Various embodiments permit the mixing of varying levels of redundancy within a single system with shared processing, communication, control, power supply, input/output, switch and/or timing signal resources.

Alternative embodiments, examples, and modifications which would still be encompassed by the disclosure may be made by those skilled in the art, particularly in light of the foregoing teachings. Further, it should be understood that the terminology used to describe the disclosure is intended to be in the nature of words of description rather than of limitation.

Those skilled in the art will also appreciate that various adaptations and modifications of the preferred and alternative embodiments described above can be configured without departing from the scope and spirit of the disclosure. Therefore, it is to be understood that, within the scope of the appended claims, the disclosure may be practiced other than as specifically described herein.

What is claimed is:

1. An interface architecture comprising:
a circuit board layout including slots for electrically coupling to (n) number of acquisition boards, each acquisition board being configured to accommodate (m) universal channels;
wherein the interface architecture is connectable to a plurality of terminal board types; and
wherein the interface architecture can be configured to accommodate a predetermined multiple of (m) universal channels.

2. The interface architecture of claim 1, wherein the architecture is a universal input/output (I/O) pack.

3. The interface architecture of claim 1, wherein the architecture is a discrete input pack.

4. The interface architecture of claim 1, wherein the circuit board layout further comprises slots for coupling to a carrier board.

5. The interface architecture of claim 1, wherein each acquisition board includes carrier board functionality.

6. The interface architecture of claim 1, wherein the universal channels are independently programmable.

7. The interface architecture of claim 1, wherein the plurality of terminal board types includes at least one of a 16 channel simplex, a 32 channel simplex, and a 16 channel dual triple mode redundancy (TMR) type.

8. The interface architecture of claim 1, wherein (m) is 16, and wherein the predetermined multiple equals (n).

9. The interface architecture of claim 1, wherein each channel is responsive to at least 8 different signals.

10. A universal input/output (I/O) interface architecture, comprising:
a circuit board layout including slots for electrically coupling to (n) number of acquisition boards, each acquisition board being configured to accommodate (m) universal channels;
wherein the interface architecture is connectable to a plurality of terminal board types; and
wherein the interface architecture can be configured to accommodate a predetermined multiple of (m) universal channels.

11. The interface architecture of claim 10, wherein the architecture is a universal input/output (I/O) pack.

12. The interface architecture of claim 10, wherein the architecture is a discrete input pack.

13. The interface architecture of claim 10, wherein the circuit board layout further comprises slots for coupling to a carrier board.

14. The interface architecture of claim 10, wherein each acquisition board includes carrier board functionality.

15. The interface architecture of claim 10, wherein the universal channels are independently programmable.

16. The interface architecture of claim 10, wherein the plurality of terminal board types includes at least one of a 16 channel simplex, a 32 channel simplex, and a 16 channel dual triple mode redundancy (TMR).

17. The interface architecture of claim 10, wherein (m) is 16, and wherein the predetermined multiple equals (n).

18. The interface architecture of claim 10, wherein each channel is responsive to at least 8 signals.

19. The interface architecture of claim 1, wherein the channels are software configurable.

20. The interface architecture of claim 1, wherein the universal I/O interface architecture is configured for hot swapping.
